(19) United States
(12) Patent Application Publication
(10) Pub. No.: US 2019/0160892 A1
(43) Pub. Date: May 30, 2019

(54) CONTROLLER FOR A GROUND CONNECTION DEVICE, GROUND CONNECTION DEVICE, AND METHOD FOR THE AUTOMATIC ADJUSTMENT OF A GROUND CONNECTION DEVICE

(71) Applicant: Orange, Paris (FR)

(72) Inventors: Régis Esnault, Châtillon Cedex (FR); William Correa, Châtillon Cedex (FR); Dominique Jezequel, Châtillon Cedex (FR)

(21) Appl. No.: 16/204,978

(22) Filed: Nov. 29, 2018

(30) Foreign Application Priority Data
Nov. 30, 2017 (FR) 1761426

(51) Int. Cl. B60C 23/00; B60G 17/0165; B60G 17/018; B60G 17/0195; G01M 17/02

(52) U.S. Cl. CPC B60C 23/002; B60G 17/0165; G01M 17/02; B60G 17/0195; B60G 17/018

(57) ABSTRACT

Embodiments described herein relate to the field of transport, in particular motor vehicle transport, and to a controller for a ground connection device of a vehicle: such as a tire, a shock absorber, etc. A controller is able to automatically adjust at least one ground connection device of a vehicle as a function of a predicted item of data characteristic of the current journey of the vehicle on the basis of data supplied by at least one sensor of the ground connection device. Thus, the controller makes it possible to optimize the stability of the vehicle regardless of the journey, in particular on a deteriorated road or on bends, in order to avoid the vehicle leaving its trajectory, by taking into consideration various characteristics in relation to the journeys, such as speed, the state of the road surface, weather conditions, the pressure of the tires, or certain accidents.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Technical Field

Embodiments described herein relate to the field of transport, in particular motor vehicle transport. Certain embodiments pertain to a controller for a ground connection device of a vehicle, able in particular to automatically adjust the pressure of tire(s) and/or the position of shock absorber(s), etc.

### Description of the Related Art

In the field of transport, numerous ground connection devices contribute to the safety of the vehicle by ensuring that the vehicle is in contact with the ground, and in particular that the vehicle is stable.

Tires ensure that the wheels of the vehicle are in contact with the ground while affording a certain grip, absorption of shocks and vibrations, facilitating travel for vehicles. When driving, they are the site of significant dissipations of energy that are linked essentially to the deformation of the tire in relation to the weight of the vehicle that said tire has to bear and to the forces that arise on bends, acceleration and braking, etc. This may lead to the tread of the tire being destroyed if the latter is underinflated. Now, an overinflated or underinflated tire leads to a reduction in grip, which may be hazardous on a bend or when braking, by increasing the braking distance. French road safety figures indicate that, in 2003, tires were associated with 9% of fatal accidents that occurred on highways.

An underinflated tire undergoes greater deformation of the sidewalls and of the tread, the main consequences of which are faster wear of the tire, poor road holding, in particular in rain, an increased risk of bursting linked to excessive heating, and an increase in the vehicle's fuel consumption. An overinflated tire also wears more quickly but at the centre of the tread, and is more sensitive to the tearing away of rubber (in particular skidding). The sidewalls of the tire are more rigid, thereby reducing the contact surface between the tire and the ground and therefore comfort and grip.

To alert the driver of the risks in relation to the pressure of the tires, some modern vehicles are equipped with an automatic tire pressure monitoring system (TPMS). Thus, the driver, who is alerted that a tire is underinflated or overinflated, is able to stop at a service station in order to correct the pressure of the tires. As the pressure is set manually, the driver either puts off correcting the pressure of the tire (in particular due to a lack of time or the lack of an available inflator) or corrects the pressure of the tire but under cold conditions, leading to underinflation of the tire (since the recommended pressure is measured in cold conditions).

To improve safety performance in relation to tires, in 2012 Goodyear® proposed an automatic inflation technology, called air maintenance technology (ATM), which ensures that the recommended pressure is kept in the tires without the aid of an external pump.

However, depending on the speed of the vehicle on a journey and/or on the quality of the road (bend, type of coating, etc.), the recommended pressure is not optimally tailored to the grip of the vehicle and therefore to safety. Specifically, a driver of an off-road vehicle adjusts the pressure of the tires depending on the terrain on which the vehicle is travelling: for example, a high pressure for hard ground, a low pressure on soft, uneven, slippery ground, etc. It is for this reason, in particular for off-road vehicles, that Syegon provides an inflation-deflation system Syegon power+® that comprises pressure sensors and an electropneumatic central system that attach to the tires, and a remote controller. Thus, the driver uses the remote controller to choose between 4 different pre-programmed pressures, and the inflation-deflation system modifies the pressure of the tires as a result.

This manual adjustment of the pressure is subject to driver errors: command input errors, errors in evaluating the features of the upcoming journey, etc., and is generally implemented before the start of a journey because it is complex to implement during the journey (the driver is already occupied with driving). Therefore, if the driver makes an error when selecting the pressure or he modifies his journey, the pressure of the tires will not, or respectively will no longer, be tailored to the journey, with the known risks in terms of grip of the vehicle.

Other ground connection devices are installed on vehicles that contribute to the stability and therefore to the safety of the vehicle, such as suspension systems, which form an elastic connection between the hanging loads of the vehicle (in particular the chassis) and the non-hanging loads (in particular the wheels). The use of the suspension system is imposed by the unevenness of the surface on which the vehicle travels. It reduces the impact thereof on the vehicle, reducing mechanical fatigue and excessive wear, improving passenger comfort and maintaining contact between the wheels and the ground in spite of the unevenness thereof: a condition which is essential to road holding.

A suspension system generally includes at least one shock absorber. The shock absorber may possibly be adjusted depending on the terrain on which the vehicle is travelling. For example, a shock absorber may be adjusted into three distinct positions: open (that is to say that the shock absorber is left completely free), intermediate (the shock absorber is left partly free, that is to say that everything proceeds as if the shock absorber being used were shorter), and blocked (that is to say that the shock absorber does not operate, that it to say that everything proceeds as if the vehicle were not equipped with this shock absorber). In particular, the driver is able to adjust the shock absorber manually depending on the terrain. For example,
on a flat and hard terrain, he may block the shock absorber in order to prevent a suspension system pumping phenomenon,
on a slightly rugged or uphill terrain, he may put the shock absorber into an intermediate position for a compromise between performance and driveability;
on a very rugged terrain, the shock absorber is open, etc.

This manual adjustment of the shock absorber is subject to driver errors: adjustment input errors, errors in evaluating the features of the upcoming journey, etc., and is implemented before the start of a journey. Therefore, if the driver makes an error when adjusting the shock absorber or he modifies his journey, the shock absorber will not, or respectively will no longer, be tailored to the journey, with the known risks in terms of stability of the vehicle.

In the context of off-road bicycles, Ei Shock® technology proposes automatic adjustment of the shock absorber depending on data measured by sensors that are placed on the fork, the pedal system and the stem. The adjustment is thus made a posteriori. The risk of a lack of stability is always high when there is a rapid change on the journey.

Embodiments described herein provide improvements with respect to other approaches.

### SUMMARY

In one aspect, a controller is described, the controller able to automatically adjust at least one ground connection device of a vehicle as a function of a predicted item of data characteristic of the current journey of the vehicle on the basis of data supplied by at least one sensor of the ground connection device.

Thus, the controller automatically adjusting the ground connection device as a function of predicted data characteristic of the current journey of the connection device on the basis of data from a sensor of the ground connection device makes it possible to optimize the stability of the vehicle regardless of the journey, in particular on a deteriorated road or on bends, etc., in particular in order to avoid the vehicle leaving its trajectory, by taking into consideration various characteristic data in relation to the journeys, such as speed, the state of the road surface, weather conditions, the pressure of the tires, etc.; and certain accidents.

In some embodiments, the ground connection device of the vehicle is at least one device from among the following:
at least one shock absorber of a suspension system between the hanging loads of the vehicle and the non-hanging loads of the vehicle;
at least one tire of the vehicle.

In some embodiments, the controller includes at least one transmitter for transmitting a tire pressure command to a compressor that is installed in the vehicle, the commanded pressure depending on a predicted item of data characteristic of the current journey of the vehicle.

In some embodiments, the controller includes at least one transmitter for transmitting a position of a shock absorber to a blocker that is able to at least partly block the shock absorber, the commanded shock absorber position depending on a predicted item of data characteristic of the current journey of the vehicle.

In another aspect, a ground connection device of a vehicle is described, the ground connection device able to be adjusted upon the command of a controller as a function of a predicted item of data characteristic of the current journey of the vehicle on the basis of data supplied by at least one sensor of the ground connection device.

In another aspect, a method is described for the automatic adjustment of at least one ground connection device of a vehicle as a function of a predicted characteristic of the current journey of the vehicle on the basis of data supplied by at least one sensor of the ground connection device.

Thus, the automatic adjustment method makes it possible to optimize the stability of the vehicle regardless of the journey, in particular on a deteriorated road or on bends, etc., in particular in order to avoid the vehicle leaving its trajectory, by taking into consideration various characteristics in relation to the journeys, such as speed, the state of the road surface, weather conditions, the pressure of the tires, etc.; and certain accidents.

Furthermore, this makes it possible to optimize comfort for the passengers of the vehicle (including the driver) during the trip by taking into consideration various characteristics in relation to the journeys, such as speed, the state of the road surface, weather conditions, the pressure of the tires, etc.

In some embodiments, the predicted characteristic item of data depends on a log of the ground connection device of the vehicle that associates at least one parameter of the ground connection device of the vehicle during a previous journey with at least one item of data characteristic of the previous journey.

Thus, the adjustment takes into account not only characteristic data specific to the journey: type of road surface, type of route, etc., but also data in relation to the vehicle-driver or vehicle/pilot system, since it takes into account data in relation to previous journeys (speed, trajectory, etc., as a function of the type of road surface and/or route and/or weather conditions, etc.).

In some embodiments, the characteristic item of data is predicted using a model established using automatic learning.

Thus, if the vehicle has not yet taken the current trip or at least has not taken it in the current conditions (modification of the state of the road surface, of weather conditions, etc.), a model established using automatic learning as a function of previous journeys still makes it possible to tailor the vehicle to the current journey.

In some embodiments, the automatic learning is performed on the basis of a log of the ground connection device of the vehicle that associates at least one parameter of the ground connection device of the vehicle during a previous journey with at least one item of data characteristic of the previous journey.

In some embodiments, the adjustment method includes predicting the current journey of the vehicle on the basis of data supplied by at least one sensor of the ground connection device.

In some embodiments, the automatic adjustment method includes generating a log of the ground connection device of the vehicle that associates at least one parameter of the ground connection device of the vehicle during a previous journey with at least one item of data characteristic of the previous journey.

In some embodiments, the automatic adjustment method includes automatic learning on the basis of the generated log that supplies a behavioural model of the ground connection device.

In some embodiments, the automatic adjustment method includes estimating the current journey as a function of the generated log, the estimated current journey supplying at least the predicted item of data characteristic of the current journey.
In some embodiments, an item of data characteristic of a current journey includes at least one element from among the following:
speed of the vehicle,
quality of the road,
type of route,
weather

In some embodiments, the various steps of the method according to the invention are implemented by software or a computer program, this software comprising software instructions intended to be executed by a data processor of a device forming part of a controller for a ground connection device of a vehicle and being designed to command the execution of the various steps of this method.

In another aspec, a program is described comprising program code instructions for executing the steps of the automatic adjustment method when said program is executed by a processor.

This program may use any programming language, and be in the form of source code, object code, or intermediate code between source code and object code, such as in a partially compiled form, or in any other desirable form.

### BRIEF DESCRIPTION OF THE DRAWINGS

The features and advantages of the described embodiments will become more clearly apparent upon reading the description, given by way of example, and the attached figures, in which:

FIG. 1 shows a simplified diagram of a controller for a ground connection device.

FIGS. 2a, 2b and 2c show simplified diagrams of the implementation of a controller according to the invention, respectively connected to at least one tire, connected to at least one shock absorber, in a vehicle.

FIG. 3 shows a simplified diagram of a method for the automatic adjustment of a ground connection device.

### DETAILED DESCRIPTION

As described herein, the term route is used to mean all surfaces that are able to be driven on, such as roads, expressways, highways, tracks, paths, but also runways, railways, etc.

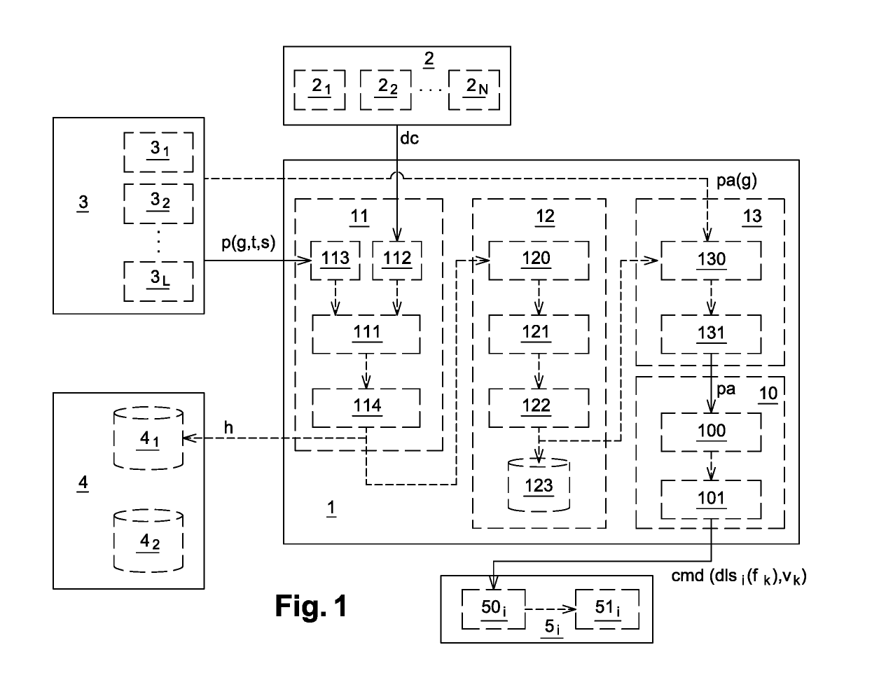

FIG. 1 illustrates a simplified diagram of a controller for a ground connection device.

The controller 1 is able to automatically adjust at least one ground connection device 5i of a vehicle as a function of a predicted item of data pc1 . . . pcM characteristic of the current journey pa of the vehicle on the basis of data dc supplied by at least one sensor 2i of the ground connection device 5i.

In particular, the controller 1 includes at least one supervisor 10 able to transmit the appropriate adjustment vk to the ground connection device 5i.

In particular, the controller 1 includes a calculator 100 for calculating an adjustment value vk for a parameter fk of the ground connection device 5i. This calculator 100 is able to determine the adjustment value vk in particular on the basis of a function or of rules for optimizing the ground connection device 5i to at least one item of data pc1 . . . pcM characteristic of a journey. These optimization rules are in particular stored in a rule database (not illustrated). The supervisor 10 in particular includes this calculator 100.

In particular, the controller 1 includes a generator 101 for generating a command cmd(dlsi(fk),vk) to adjust a ground connection device. This command cmd includes in particular an adjustment value vk for a parameter fk of the ground connection device 5i. Either the controller 1 is able to transmit this command directly to the parameter fk of the ground connection device 5i in order to trigger the adjustment, or the command cmd also includes an identifier of the parameter fk to be adjusted and the controller 1 is able to transmit the command to the ground connection device 5i, which is able to adjust the parameter fk to the value vk. This command generator 101 is in particular implemented in the supervisor 10.

In particular, the controller 1 includes at least one recorder 11 for recording previous journeys that is able to store at least some data sensed during at least one previous journey dc in relation with at least one of the items of data g, t, s characteristic of the previous journey p(g, t, s).

In particular, the controller 1 includes a receiver 112 for receiving supplied data dc supplied by one or more sensors 21 . . . 2N, in particular a sensor of the ground connection device 25i and/or an assembly/system of sensors 2 including a plurality of sensors 21 . . . 2N of the vehicle, such as camera(s), tire sensors, rain sensor(s), accelerometers, etc. These sensors are in particular connected sensors whose data logs are possibly kept remotely. This receiver 112 for receiving sensed data is in particular implemented in the recorder 11 for recording previous journeys.

In particular, the controller 1 includes a receiver 113 for receiving data in relation to a journey p(g, t, s) in progress during the sensing of data dc. This receiver 113 for receiving data in relation to the journey is in particular implemented in the recorder 11 for recording previous journeys.

In particular, the controller 1 includes a coupler 111 for coupling the supplied data dc supplied by one or more sensors 21 . . . 2N, in particular a sensor of the ground connection device 25i, with data in relation to a journey p(g, t, s) in progress during the sensing of the data dc. The associated data form a log of the behaviour of the ground connection devices during previous journeys. This coupler 111 is in particular implemented in the recorder 11 for recording previous journeys.

In particular, the controller 1 includes a recorder 114 for recording a log of the behaviour of the ground connection devices during previous journeys, formed in particular of supplied data dc supplied by one or more sensors 21 . . . 2N, in particular a sensor of the ground connection device 25i, associated with data in relation to a journey p(g, t, s) in progress during the sensing of data dc. The log is in particular recorded in a log database 41. This log recorder 114 is in particular implemented in the recorder 11 for recording previous journeys.

In particular, the controller 1 includes at least one journey modeller 12, in particular for a predetermined vehicle, and possibly driven by a given user, in particular a modeller of the behaviour of the ground connection device.

In particular, the controller 1 includes an automatic learning device 120. The automatic learning device 120 uses a log of the ground connection device of the vehicle h(dsli) that associates at least one parameter fk of the ground connection device of the vehicle during a previous journey p with at least one item of data g, t, s characteristic of the previous journey p, in particular a log generated by the coupler 111. The automatic learning device 120 possibly recovers the logs of the previous journeys that are recorded in a log database 41. The vehicle is associated with a logging system 4 that includes in particular the log database 41 of the behavior of the ground connection devices of the vehicle, a memory 42 that stores the wheelbase and the loading of the vehicle, such as a wheelbase and loading log database, and possibly other log databases or memories in relation to other sensors of the vehicle, such as a multimedia database (not illustrated) that keeps a video log of the cameras of the vehicle, etc. This automatic learning device 120 is in particular implemented in the journey modeller 12.

In particular, the controller 1 includes a model generator 121 for generating models on the basis of the result of the automatic learning device 120. A recorder 122 possibly stores the created model in a model database 123. The model generator 121 and/or its recorder 123 are in particular implemented in the journey modeller 12.

In particular, the controller 1 includes at least one journey predictor 13 able to predict a journey as a function of sensed data dc.

In particular, the controller 1 includes a model loader 130 for loading a model as a function of the current journey pa(g), either directly from the modeller 12 and/or from the model generator 121 and/or from a model database 123. The current journey pa(g) is supplied in particular by a navigation device 31, for example in the form of a series of geographical coordinates, or of two geographical extremities of a trip: start and finish, and of routes calculated by the navigation device between these two extremities. The navigation device 31 is in particular implemented in a navigation system 3 including a route database 3L, an access device 32 for accessing road information (roadworks, traffic jams, etc.), in particular via Internet communities of Waze® and opendata type, etc., and uses the information supplied by one or more of these devices 32 . . . 3L to calculate the trip for the current journey pa. The model loader 130 is in particular implemented in the journey predictor 13.

In particular, the controller 1 includes an estimator 131 for estimating the current journey ppa(pc1 . . . pcM) on the basis of the sensed data dc, in particular by using the generated log of previous journeys and/or the generated model. The journey estimator 131 is in particular implemented in the journey predictor 13.

In particular, the journey predictor 13 supplies at least one predicted item of data pc1 . . . pcM characteristic of the current journey, or even the predicted journey ppa, to the supervisor 10, which is able to transmit, to the ground connection device 5i, a tailored adjustment vk to at least one predicted characteristic item of data supplied by the predictor 13, in particular in the form of a command cmd (dlsi(fk), vk).

In particular, the ground connection device 5i of the vehicle is at least one device from among the following:
at least one shock absorber of a suspension system between the hanging loads of the vehicle and the non-hanging loads of the vehicle;
at least one tire of the vehicle.

In particular, the ground connection device 5i includes the ground connection element as such 50i, such as a shock absorber, a tire, and one or more of the following elements:
a sensor of the ground connection device 25i,
an electromechanical device 51i, such as a microcontroller or a servomotor, in particular a shock absorber blocker or a compressor for a tire, etc.

In one particular embodiment, when a vehicle travels for the first time on a road, the controller of the vehicle may interrogate a log database common between a plurality of vehicles.

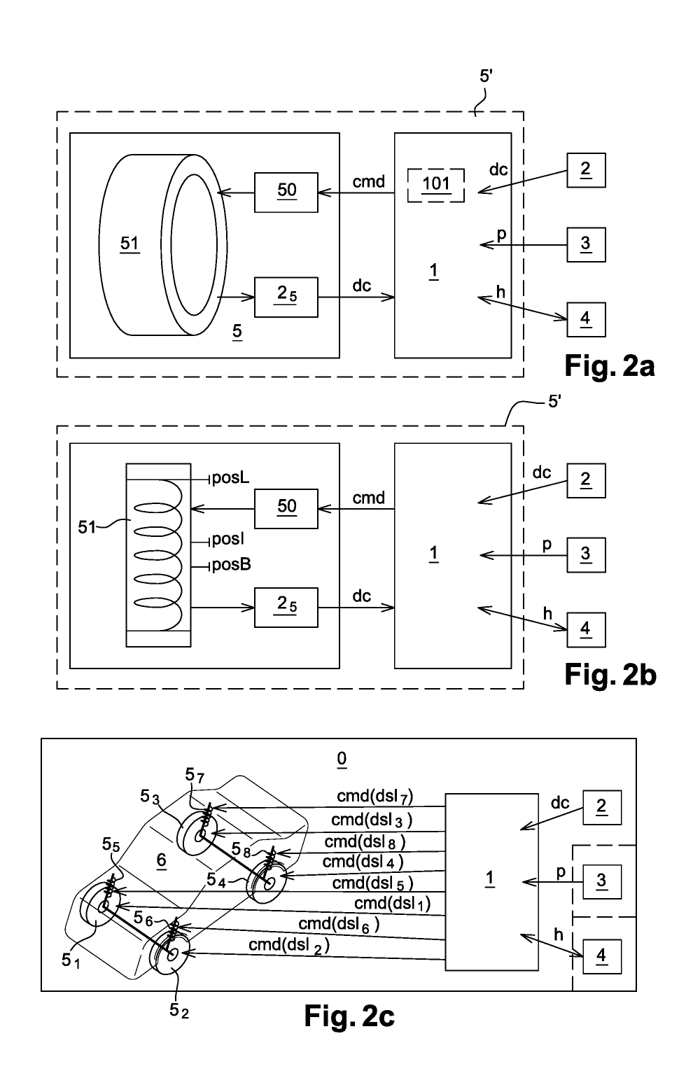

FIG. 2a illustrates a simplified diagram of the implementation of a controller, connected to at least one tire.

A ground connection device 5 of a vehicle, in particular a tire, is able to be adjusted upon the command of a controller 1 as a function of a predicted item of data pc1 . . . pcM characteristic of the current journey pa of the vehicle on the basis of data dc supplied by at least one sensor 25 of the ground connection device 5.

In particular, the controller 1 includes at least one transmitter 101 for transmitting a tire pressure command to a compressor 50 that is installed in the vehicle (in particular in the ground connection device 5). The commanded pressure depends on the predicted item of data characteristic of the current journey of the vehicle.

The ground connection device 5′ possibly includes, in addition to the tire 51, the compressor 50 and the sensor 25, the controller 1.

One or more sensors 2, including at least one sensor 25 of the tire 51 of the vehicle, supply sensed data dc to the controller 1. In particular, the at least one sensor 25 of the tire supplies tire pressure data, and possibly other data such as a degree of wear, the temperature of the tire, etc.

In particular, the controller 1 records these data with information in relation to the journey during the sensing of these data, in particular in the form of a log h in a logging system 4. The information in relation to the journey are supplied to the controller 1, for example, by a navigation system 3.

In particular, the controller 1 uses the sensed data dc from the sensing system 2 (including from the sensor 25 of the ground connection device 5), in particular by consulting the logs h of the logging system 4, to command cmd the compressor 50. For example, the controller 1 models the behaviour of the ground connection device 5 as a function of the current journey in order to determine the adjustment to be made.

FIG. 2b illustrates a simplified diagram of the implementation of a controller with at least one shock absorber.

FIG. 2c illustrates a simplified diagram of the implementation of a controller in a vehicle.

The vehicle 0 has four wheels equipped with four tires 51, 52, 53 and 54, and four suspension systems linking the chassis 6 of the vehicle 0 to each of the four wheels. Each suspension system respectively includes a shock absorber 55, 56, 57 and 58.

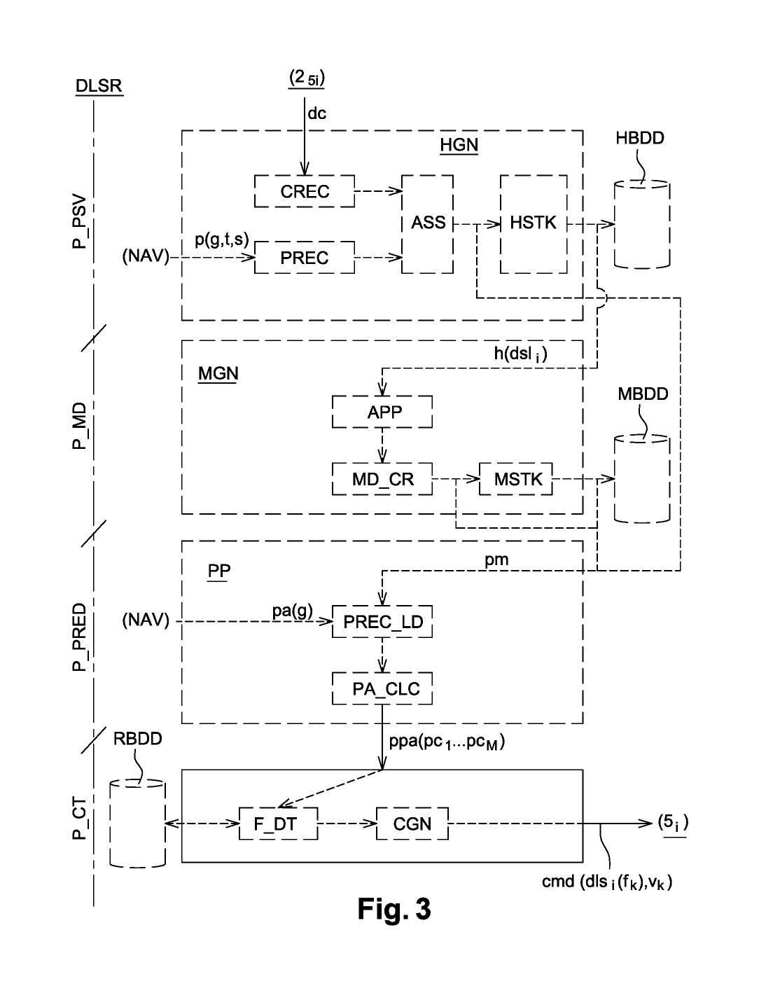

Each ground connection device 51 to 58 possibly has its own controller 1. In one alternative embodiment illustrated by FIG. 3a, the vehicle 0 includes a controller 1 that is able automatically to adjust a plurality of or even all of the ground connection devices 51 to 58 of the vehicle. Thus, the calculations by the controller 1 may be shared in order to adjust a plurality of ground devices, reducing the calculating costs for the automatic adjustment of all of the ground devices of a vehicle.

The tires 51, 52, 53 and 54 of the vehicle 0 are able to be adjusted upon the command of the controller 1 as a function of a predicted item of data pc1 . . . pcM characteristic of the current journey pa of the vehicle on the basis of data dc supplied by at least one sensor 25 of the ground connection device 5.

In particular, the controller 1 includes at least one transmitter 101 for transmitting a tire pressure command to a compressor (not illustrated) that is installed in the vehicle (in particular in the ground connection device 51, 52, 53 and 54 or shared pairwise or by all of the tires). The commanded pressure depends on the predicted item of data characteristic of the current journey of the vehicle.

One or more sensors 2, including at least one sensor 25 of the tire 51 of the vehicle, supply sensed data dc to the controller 1. In particular, for each tire 51, 52, 53 and 54, the at least one sensor of the tire (not illustrated) supplies tire pressure data, and possibly other data such as a degree of wear, the temperature of the tire, etc.

A ground connection device 5 of a vehicle, in particular a shock absorber, is able to be adjusted upon the command of a controller 1 as a function of a predicted item of data pc1 . . . pcM characteristic of the current journey pa of the vehicle on the basis of data dc supplied by at least one sensor 25 of the ground connection device 5.

In particular, the controller 1 includes at least one transmitter 101 for transmitting a tire pressure command to a compressor 50 that is installed in the vehicle (in particular in the ground connection device 5). The commanded pressure depends on the predicted item of data characteristic of the current journey of the vehicle.

In particular, the controller includes at least one transmitter 101 for transmitting a position of a shock absorber 55, 56, 57 and 58 to a blocker (not illustrated) that is able to at least partly block the shock absorber, the commanded shock absorber position depending on a predicted item of data characteristic of the current journey of the vehicle. The shock absorber may thus be positioned in three or more positions. For example, the transmitter 101 transmits one of the following three positions: free posL, intermediate posI or blocked posB.

One or more sensors 2, including at least one sensor 25 of a shock absorber 55, 56, 57 and 58 of the vehicle, supply sensed data dc to the controller 1. In particular, the at least one sensor 25 of the shock absorber supplies data on the oscillating frequency of the shock absorber, and possibly other data such as a degree of wear, the oscillating amplitude of the shock absorber, etc.

In particular, the controller 1 records these data with information in relation to the journey during the sensing of these data, in particular in the form of a log h in a logging system 4. The information in relation to the journey are supplied to the controller 1, for example, by a navigation system 3.

In particular, the controller 1 uses the sensed data dc from the sensing system 2 (including from the sensor 25 of the ground connection device 5), in particular by consulting the logs h of the logging system 4, to command cmd the compressor connected to the tire 51, 52, 53 or 54. For example, the controller 1 models the behaviour of the ground device 5 as a function of the current journey in order to determine the adjustment to be made.

In particular, the controller 1 uses the sensed data dc from the sensing system 2 (including from the sensor 25 of the ground connection device 5), in particular by consulting the logs h of the logging system 4, to command cmd the blocker connected to the shock absorber 55, 56, 57 or 58. For example, the controller 1 models the behaviour of the ground device 5 as a function of the current journey in order to determine the adjustment to be made.

Thus, the controller makes it possible automatically to adjust the shock absorbers and the tires of a driven or autonomous vehicle, such as a car, a bicycle, a lorry, a bus, an aeroplane, a train, etc. when moving. The adjustment of these shock absorbers and of these tires depends primarily on characteristics of journeys, such as the speed of the vehicle and the quality of the route being taken.

In particular, the controller 1 is able to predict the journey taken by a driver of the vehicle: trip, speed, etc. Predicting the journey allows the controller 1 to optimize the adjustment of the ground connection devices of the vehicle.

In particular, the controller includes a plurality of elements for optimizing this prediction:
a recorder 11 for recording previous journeys, able to create a log of the trips journeyed by a vehicle, in particular driven by a given user, and travel speeds;
a journey modeller 12 able to create a model of this log using in particular what are called machine learning methods in English, such as hidden Markov models, as they are known in English, or statistical models, for example conditional random field models, etc.;
a journey predictor 13 able, during travel of the vehicle, to estimate a journey, in particular a trip and the speed of the vehicle, by using the models that are created.

In particular, the controller(s) for ground connection devices of a first vehicle are able to share data: logs, model with the ground devices of a second vehicle distinct from the first one. For example, if it is the second vehicle travels for the first time on a road, the controller(s) recover(s) data in relation to the journey (missing data): trajectory, speed, logs and/or models, etc. from controller(s) for ground connection device(s) of the first vehicle. The controllers for ground connection devices of two distinct vehicles share data in particular using a V2V protocol (example: 802.11.P or 5G).

FIG. 3 illustrates a simplified diagram of a method DLSR for the automatic adjustment of a ground connection device.

The method DLSR for the automatic adjustment of a ground connection device automatically adjusts cmd(dsli(fk),vk) at least one ground connection device 5i of a vehicle as a function of a predicted characteristic pc1 . . . pcM of the current journey pa of the vehicle on the basis of data dc supplied by at least one sensor 25i of the ground connection device 5i.

In particular, the predicted characteristic item of data pc1 . . . pcM depends on a log of the ground connection device of the vehicle h(dsli) that associates at least one parameter fk of the ground connection device of the vehicle during a previous journey p with at least one item of data g, t, s characteristic of the previous journey p.

In particular, the characteristic item of data pc1 . . . pcM is predicted using a model pm established using automatic learning APP.

In particular, the automatic learning APP is performed on the basis of a log of the ground connection device of the vehicle h(dsli) that associates at least one parameter fk of the ground connection device of the vehicle during a previous journey p with at least one item of data g, t, s characteristic of the previous journey p.

In particular, the method DLSR for the automatic adjustment of a ground connection device includes predicting the current journey PP of the vehicle on the basis of supplied data dc supplied by at least one sensor 25i of the ground connection device 5i.

In particular, the automatic adjustment method DLSR includes generating a log HGN of the ground connection device of the vehicle that associates at least one parameter fk of the ground connection device of the vehicle during a previous journey p with at least one item of data g, t, s characteristic of the previous journey p.

In particular, the automatic adjustment method DLSR includes automatic learning APP on the basis of the generated log h(dsli) that supplies a journey model pm as a function of characteristics g of the journey pa.

In particular, the automatic adjustment method DLSR includes estimating PP the current journey as a function of the generated log h(dsli), the estimated current journey ppa supplying at least the predicted item of data pc1 . . . pcM characteristic of the current journey.

In particular, an item of data pc1 . . . pcM characteristic of a current journey includes at least one element from among the following:
speed of the vehicle s,
quality of the road qr,
type of route t,
weather w,
coordinates of the journey g,
at least one item of data characteristic of the vehicle:
   tare weight,
   current weight
   drag coefficient,
   wheelbase,
   camber,
   wheel alignment,
   pull,
   anti-dive,
   balance,
at least one characteristic item of data linked to the geometry of the suspension system;
at least one characteristic item of data on the profile of the driver: in particular the driving type; “sporty”, “environmentally friendly”, “responsible father”, etc.
etc.

The sensed data dc supplied by one or more sensors 2n, in particular a sensor of the ground connection device 25i, are used by the method DLSR for the automatic adjustment of a ground connection device 5i to tailor the adjustment of the ground connection device 5i as a function of the current journey pa.

In particular, the method DLSR for the automatic adjustment of a ground connection device 5i includes at least one control phase P_CT during which the automatic adjustment method transmits the tailored adjustment vk to the ground connection device 5i.

In particular, the method DLSR for the automatic adjustment of the ground connection device 5i includes determining F_DT an adjustment value vk for a parameter fk of the ground connection device 5i. This determination F_DT is performed in particular on the basis of a function or of rules for optimizing the ground connection device 5i to at least one item of data pc1 . . . pcM characteristic of a journey. These optimization rules are in particular stored in a rule database RBDD. This determination F_DT is performed in particular during the control phase P_CT.

In particular, the method DLSR for the automatic adjustment of the ground connection device 5i includes generating CGN a command cmd(dlsi(fk),vk) to adjust a ground connection device. This command cmd includes in particular an adjustment value vk for a parameter fk of the ground connection device 5i. Either the adjustment method DLSR transmits this command directly to the parameter fk of the ground connection device 5i in order to trigger the adjustment, or the command cmd also includes an identifier of the parameter fk to be adjusted and the adjustment method DLSR transmits the command to the ground connection device 5i, which adjusts the parameter fk to the value vk. This command generation is performed in particular during the control phase P_CT.

In particular, the method DLSR for the automatic adjustment of a ground connection device 5i includes at least one phase of recording previous journeys P_PSV, during which the automatic adjustment method stores at least some data sensed during at least one previous journey dc in relation with at least one of the items of data g,t,s characteristic of the previous journey p(g, t, s).

In particular, the method DLSR for the automatic adjustment of a ground connection device includes receiving CREC supplied data dc supplied by one or more sensors 2n, in particular a sensor of the ground connection device 25i. This reception CREC of sensed data is in particular performed during the phase of recording previous journeys P_PSV.

In particular, the method DLSR for the automatic adjustment of a ground connection device includes receiving PREC data in relation to a journey p(g, t, s) in progress during the sensing of data dc. This reception PREC of data in relation to the journey is in particular performed during the phase of recording previous journeys P_PSV.

In particular, the method DLSR for the automatic adjustment of a ground connection device includes associating ASS supplied data dc supplied by one or more sensors 2n, in particular a sensor of the ground connection device 25i, with data in relation to a journey p(g, t, s) in progress during the sensing of data dc. The associated data form a log of the behaviour of the ground connection devices during previous journeys. This association ASS is in particular performed during the phase of recording previous journeys P_PSV.

In particular, the method DLSR for the automatic adjustment of a ground connection device includes recording HSTK a log of the behaviour of the ground connection devices during previous journeys, formed in particular of supplied data dc supplied by one or more sensors 2n, in particular a sensor of the ground connection device 25i, associated with data in relation to a journey p(g, t, s) in progress during the sensing of data dc. The log is in particular recorded in a log database HBDD. This log recording HSTK is in particular performed during the phase of recording previous journeys P_PSV.

The method DLSR for the automatic adjustment of a ground connection device possibly includes generating a log HGN, including one or more of the following steps:
receiving CREC supplied data dc supplied by one or more sensors 2n, in particular a sensor of the ground connection device 25i,
receiving PREC data in relation to a journey p(g, t, s) in progress during the sensing of data dc, in particular during the reception CREC,
associating ASS the supplied data dc supplied by one or more sensors 2n, in particular a sensor of the ground connection device 25i, in particular data supplied at reception CREC, with data in relation to a journey p(g, t, s) in progress during the sensing of data dc, in particular data in relation to the journey and received by the reception PREC. The associated data form a log of the behaviour of the ground connection devices during previous journeys.
recording HSTK a log of the behaviour of the ground connection devices during previous journeys, formed in particular of supplied data dc supplied by one or more sensors 2n, in particular a sensor of the ground connection device 25i, associated with data in relation to a journey p(g, t, s) in progress during the sensing of data dc. In particular, the recording HSTK stores the log supplied by the association ASS.

This log generation HGN is in particular performed during the phase of recording previous journeys P_PSV.

In particular, the method DLSR for the automatic adjustment of a ground connection device 5i includes at least one journey modelling phase P_MD, in particular for a predetermined vehicle, and possibly driven by a given user, in particular for modelling the behaviour of the ground connection device.

In particular, the method DLSR for the automatic adjustment of a ground connection device 5i includes automatic learning APP. The automatic learning APP is performed on the basis of a log of the ground connection device of the vehicle h(dsli) that associates at least one parameter fk of the ground connection device of the vehicle during a previous journey p with at least one item of data g, t, s characteristic of the previous journey p, in particular a log generated by the association ASS. The automatic learning APP possibly recovers the logs of the previous journeys that are recorded in a log database BDD. This automatic learning APP is in particular performed during the journey modelling phase P_MD.

In particular, the method DLSR for the automatic adjustment of a ground connection device 5i includes creating a model MD_CR on the basis of the result of the automatic learning APP. The created model is possibly recorded MSTK in a model database MBDD. For example, the model database is remote from the vehicle, making it possible to group together the models of a user for various types of vehicle (or even various types of ground connection equipment: summer tire or winter tire, various shock absorber brands, etc.). The model creation MD_CR and/or recording MSTK thereof are in particular performed during the journey modelling phase P_MD.

The method DLSR for the automatic adjustment of a ground connection device possibly includes generating a model MGN, including one or more of the following steps:
automatic learning APP is performed on the basis of a log of the ground connection device of the vehicle h(dsli) that associates at least one parameter fk of the ground connection device of the vehicle during a previous journey p with at least one item of data g, t, s characteristic of the previous journey p;
creating a model MD_CR on the basis of the result of the automatic learning, and
recording MSTK the created model.

The model generation MGN is performed in particular during the journey modelling phase P_MD.

Thus, when a user positions themselves at the steering wheel of a vehicle, the corresponding model created beforehand may be loaded PREC_LD in order to predict characteristic data, and more generally in order to estimate the current journey PA_CLC.

In particular, the method DLSR for the automatic adjustment of a ground connection device 5i includes at least one journey prediction phase P_PRED during which a journey is predicted as a function of sensed data dc.

In particular, the method DLSR for the automatic adjustment of a ground connection device includes loading a model PREC_LD as a function of the current journey pa(g) either directly from the model generation MGN and/or from the model creation MD_CR and/or from a model database MBDD. The current journey pa(g) is supplied in particular by a navigation device NAV, for example in the form of a series of geographical coordinates, or of two geographical extremities of a trip: start and finish, and of routes calculated by the navigation device between these two extremities. The model loading PREC_LD is in particular performed during the journey prediction phase P_PRED.

In particular, the method DLSR for the automatic adjustment of a ground connection device includes estimating PA_CLC the current journey ppa(pc1 . . . pcM) on the basis of sensed data dc, in particular using the log of previous journeys that is generated HGN, ASS and/or the model that is generated MGN, MD_CR. The journey estimation is in particular performed during the journey prediction phase P_PRED.

In particular, the method DLSR for the automatic adjustment of a ground connection device includes predicting a journey PP and in particular at least one item of data pc1 . . . pcM characteristic of the current journey ppa. The journey prediction PP includes at least one of the two previous steps of loading a model PREC_LD and of estimating the current journey PA_CLC. The journey prediction PP is in particular performed during the journey prediction phase P_PRED.

In a first variant, the automatic adjustment method, at a first time, performs automatic learning, making it possible to generate a model P_MD. During this first time, called learning time, the adjustment of the ground connection device is not tailored to the journey, for example it is adjusted to a default value. At a second time, the model is not re-evaluated by the automatic adjustment method, and is used to predict data characteristic of the current journey, allowing the automatic adjustment method to command a tailored adjustment to the current journey for the ground connection device as a function of this model.

In a second variant, each journey is used to enrich the knowledge of the automatic adjustment method in relation to the behaviour of the ground connection devices, even the journeys for which a ground connection device is automatically adjusted by the automatic adjustment method. Thus, during a current journey, all of the data sensed during previous journeys are used to refine and optimize the automatic adjustment of the ground connection device, in particular by refining the behavioural model of the ground connection device and/or of the vehicle.

One particular embodiment of the method for the automatic adjustment of a ground connection device is a program comprising program code instructions for executing the steps of the automatic adjustment method when said program is executed by a processor.

Embodiments described herein also include an information medium. The information medium may be any entity or device capable of storing the program. For example, the medium may include non-transitory storage medium or a storage means, such as a ROM, for example a CD-ROM or a microelectronic circuit ROM, or else a magnetic recording means, for example a floppy disk or a hard disk.

Moreover, the information medium may be a transmissible medium such as an electrical or optical signal, which may be routed via an electrical or optical cable, by radio or by other means. The program may in particular be downloaded from a network, in particular from the Internet.

As an alternative, the information medium may be an integrated circuit in which the program is incorporated, the circuit being designed to execute or to be used in the execution of the method in question.

In another implementation, embodiments described herein are implemented by way of software and/or hardware components. With this in mind, the term “module” may correspond equally to a software component or to a hardware component. A software component corresponds to one or more computer programs, one or more subroutines of a program or, more generally, to any element of a program or of software that is able to implement a function or a set of functions in accordance with the above description. A hardware component corresponds to any element of a hardware assembly that is able to implement a function or a set of functions.

In the foregoing description, specific details are given to provide a thorough understanding of the examples. However, it will be understood by one of ordinary skill in the art that the examples may be practiced without these specific details. Certain features that are described separately herein can be combined in a single embodiment, and the features described with reference to a given embodiment also can be implemented in multiple embodiments separately or in any suitable subcombination.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A controller for a ground connection device of a vehicle, the controller configured to automatically adjust at least one ground connection device as a function of a predicted item of data characteristic of the current journey of the vehicle on the basis of data supplied by at least one sensor of the ground connection device of the vehicle.

2. The controller of claim 1, wherein the ground connection device of the vehicle comprises a device selected from among the following:
a shock absorber of a suspension system positioned between the hanging loads of the vehicle and the non-hanging loads of the vehicle; and
a tire of the vehicle.

3. The controller of claim 1, wherein the controller comprises at least one transmitter configured to transmit a tire pressure command to a compressor installed in the vehicle, wherein a pressure commanded by the tire pressure command is dependent on a predicted item of data characteristic of a current journey of the vehicle.

4. The controller of claim 1, wherein the controller comprises at least one transmitter for transmitting a position of a shock absorber to a blocker configured to at least partly block the shock absorber, the shock absorber position is dependent on a predicted item of data characteristic of the current journey of the vehicle.

5. A ground connection device of a vehicle, the ground connection device comprising at least one sensor, the ground connection device configured to be adjusted in response to a command sent by a controller as a function of a predicted item of data characteristic of a current journey of the vehicle on the basis of data supplied by the at least one sensor of the ground connection device.

6. A method for automatic adjustment of at least one ground connection device of a vehicle as a function of a predicted characteristic of a current journey of the vehicle on the basis of data supplied by at least one sensor of the ground connection device.

7. The method of claim 6, wherein the predicted characteristic item of data is dependent on a log of the ground connection device of the vehicle, the log associating at least one parameter of the ground connection device of the vehicle during a previous journey with at least one item of data characteristic of the previous journey.

8. The method of claim 6, wherein the characteristic item of data is predicted using a model established using automatic learning.

9. The method of claim 8, wherein the automatic learning is performed on the basis of a log of the ground connection device of the vehicle, the log associating at least one parameter of the ground connection device of the vehicle during a previous journey with at least one item of data characteristic of the previous journey.

10. The method of claim 8, wherein the method includes predicting the current journey of the vehicle on the basis of data supplied by at least one sensor of the ground connection device.

11. The method of claim 1, wherein the method includes generating a log of the ground connection device of the vehicle, the log associating at least one parameter of the ground connection device of the vehicle during a previous journey with at least one item of data characteristic of the previous journey.

12. The method of claim 11, wherein the automatic adjustment method includes automatic learning on the basis of the generated log that supplies a behavioral model of the ground connection device.

13. The method of claim 11, wherein the method includes estimating the current journey as a function of the generated log, the estimated current journey being used to supply at least the predicted item of data characteristic of the current journey.

14. The method of claim 6, wherein an item of data characteristic of a current journey includes at least one element from among the following:
speed of the vehicle,
quality of the road,
type of route, and
weather.

15. A non-transitory computer readable medium having stored thereon instructions, which when executed by a processor, cause the processor to implement the method of claim 6.
